(19) United States
(12) Patent Application Publication
(10) Pub. No.: US 2006/0001537 A1
(43) Pub. Date: Jan. 5, 2006

(54) System and method for remote access to security event information

(76) Inventors: Wilbert L. Blake, Boca Raton, FL (US); David M. Salcedo, Lake Worth, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 11/050,028

(22) Filed: Feb. 3, 2005

Related U.S. Application Data
(63) Continuation-in-part of application No. 10/718,447, filed on Nov. 20, 2003.
(60) Provisional application No. 60/543,727, filed on Feb. 11, 2004.

(51) Int. Cl. G08B 19/00; H04N 7/18; G08B 1/00

(52) U.S. Cl. 340/521; 348/143; 340/531

(57) ABSTRACT

A remote access system may be used to remotely access security event information from a security system. The security system may include a security event data collection system that collects event or alarm data pertaining to security events and a video surveillance system that records images of security events. The remote access system may include a consolidated database that links and stores event data and video data. A mobile access device may be used to access the stored event and video data, for example, using a wireless network. The remote access system may be used to provide notifications of events to the user of the mobile access device.

### CROSS-REFERENCE TO RELATED APPLICATIONS

This application claims the benefit of co-pending U.S. Provisional Patent Application Ser. No. 60/543,727 filed on Feb. 11, 2004, which is fully incorporated herein by reference, and is a continuation-in-part of co-pending U.S. patent application Ser. No. 10/718,447 filed on Nov. 20, 2003, which is fully incorporated herein by reference.

### TECHNICAL FIELD

The present invention relates to security systems and, in particular, security systems including a mobile component for accessing and/or receiving security data at a remote location.

### BACKGROUND INFORMATION

In known security systems, a variety of security data may be communicated to a central surveillance location from various security devices. However, security personnel who desire access to such security data must access the data from the central location. This inhibits their ability to investigate incidents in person and to be timely notified of various occurrences. For example, security personnel who wish to view live or recorded video from a security camera must do so at the central surveillance location.

In addition, security personnel may find it desirous to be actively notified of the occurrence of a security event while away from a central location and to be provided with information related to the event, such as video clips and when the event transpired.

Accordingly, there is a need for a system and method for remote access to and/or notification of security events.

### BRIEF DESCRIPTION OF THE DRAWINGS

These and other features and advantages of the present invention will be better understood by reading the following detailed description, taken together with the drawings wherein:

FIG. 1 is a schematic block diagram illustrating a security system including a system for remote access to security event information, consistent with one embodiment of the present invention;

FIG. 2 is a schematic block diagram illustrating one embodiment of the system for remote access to security event information;

FIG. 3 is a schematic block diagram illustrating another embodiment of the system for remote access to security event information; and

FIG. 4 is a flow chart illustrating a method for remote access to security event information, consistent with one embodiment of the present invention.

### DETAILED DESCRIPTION

For simplicity and ease of explanation, the invention will be described herein in connection with various exemplary embodiments thereof. Those skilled in the art will recognize, however, that the features and advantages of the invention may be implemented in a variety of configurations. It is to be understood, therefore, that the embodiments described herein are presented by way of illustration, not of limitation.

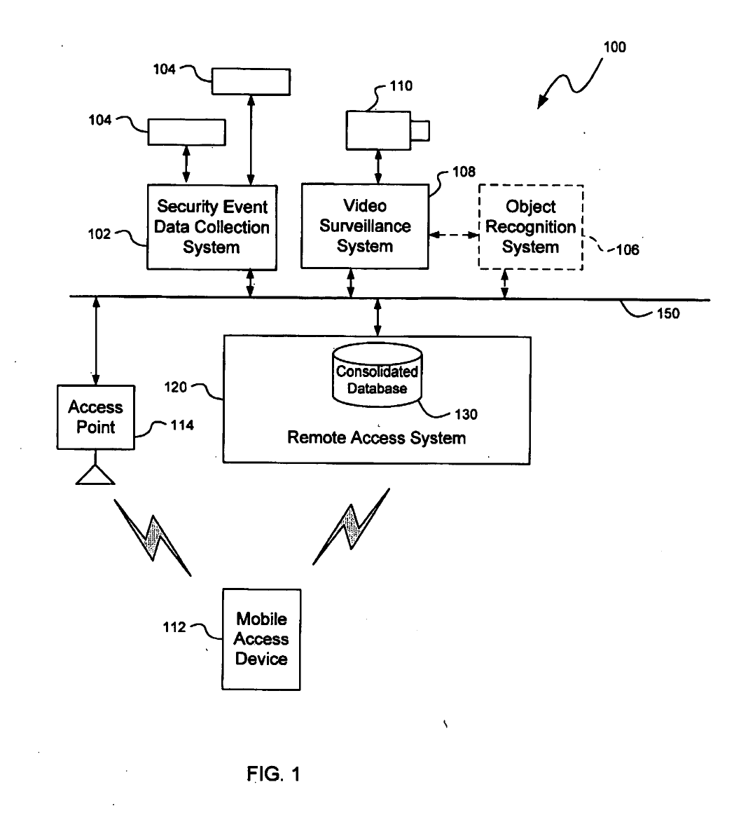

FIG. 1 is a block diagram of an exemplary security system 100 consistent with an embodiment of the present invention. In general, the security system 100 may include one or more remote or mobile access devices 112 connected to a remote access system 120 for remotely receiving and evaluating security event information. The security system 100 may include a security event data collection system 102 that collects security event data (also referred to as alarm data) from collection or detection devices 104 and a video surveillance system 108 that captures images of security events using one or more cameras 110. The security event data collection system 102, the video surveillance system 108 and the remote access system 120 may be connected to and communicate via a network 150 such as an Ethernet.

The remote access system 120 may include a consolidated database 130 that receives and stores the security data from the security event data collection system 102 and from the video surveillance system 108. The consolidated database 130 may link the event data for a particular event to the video data available for that event. The remote access system 120 may notify the access device 112 of an event and deliver event data together with video data related to the event, for example, in an event message. Alternatively, the access device 112 may initiate communication with the remote access system 120 to access the security data in the consolidated database 130. The access device 112 may be used to view the event data and to play back the video associated with the event.

The access device 112 may be a portable personal digital assistant (PDA), cellular telephone, pager, personal computer, computer terminal, laptop computer, or information kiosk. Those skilled in the art will recognize that the access device 112 may connect to and communicate with the remote access system 120 in a variety of ways. The connection may be over the internet or through a wireless network such as a wireless local area network (WLAN) or a cellular wide area network (WAN). The access device 112 may also connect directly to the network 150 through an access point 114 and may receive data directly from the collection system 102 or the video surveillance system 108.

The security event data collection system 102 may include any system for detecting and/or collecting security event data including, but not limited to, an electronic article surveillance (EAS) based system, a radio frequency identification (RFID) based system, a motion detection system, an entry/exit monitoring system, a glass window and door breakage detection system, temperature sensing system, a fire detection system, a gas detection system, an intrusion detection system, and an electronic access control system. One example of the security event data collection system 102 is the SENSORMATIC® ULTRALINK® EAS system available from ADT Security Services, Inc., a division of Tyco International Ltd. The collection devices 104 may detect security events such as detection of an active EAS tag, detection of an RFID label, a point of sale (POS) transaction, a door or window opening or breaking, or a gas or fire. When security events are detected, the data collection system 102 generates event or alarm data indicative of the detected event. The event or alarm data may include time stamps indicating a time of occurrence of the events as well as information describing the location of the event and the nature of the event or alarm.

The video surveillance system 108 may include any system for capturing images of security events. One example of the video surveillance system 118 is the INTELLEX® V 3.1 video surveillance system available from ADT Security Services, Inc., a division of Tyco International Ltd. The video camera 110 may take video of a surveillance area on a continuous basis or at predefined intervals. The surveillance area may be, for example, an exit/entrance of a retail store, an area around a cash register, an area around a protected asset, and the like. The camera 110 may be oriented in a fixed direction or the position of the camera 110 may be controlled, for example, to adjust the pan-tilt-zoom of the camera 110 and/or to position the camera 110 at various viewing angles. When the video surveillance system 108 captures images, the video surveillance system 108 may store the video data representing the recorded images on a multimedia server such as a digital video recorder (DVR) or a personal computer. The video surveillance system 108 may also store data pertaining to the recorded video such as time stamps, duration of the video clips, and a location of the surveillance area. The video surveillance system 108 may also capture and store audio associated with the images.

The security system 100 may optionally include an object recognition system 106 connected to the network 150 and/or connected directly to the video surveillance system 108. The object recognition system 106 may be configured to recognize any variety of objects entering the surveillance area. In general, the object recognition system 106 may receive live video from the camera 110 and analyze the video to detect if an object has entered the surveillance area. The object recognition system 106 may compare data representative of the detected object with data representative of a plurality of known objects to ascertain if an acceptable correlation exists. If a correlation exists, the object recognition system 106 may act as a security event data collection system and provide event data to the consolidated database 130.

Those skilled in the art will appreciate that the live video from the camera 110 may be communicated to the object recognition system 106 and video surveillance system 108 in a variety of ways, e.g., through network cables or a wireless connection. Those skilled in the art will recognize that the object recognition system 106 may include a computer provided in a variety of known configurations to analyze the live video from the camera 110 and/or store information about the video, as well as information about any events associated with or detectable from the video.

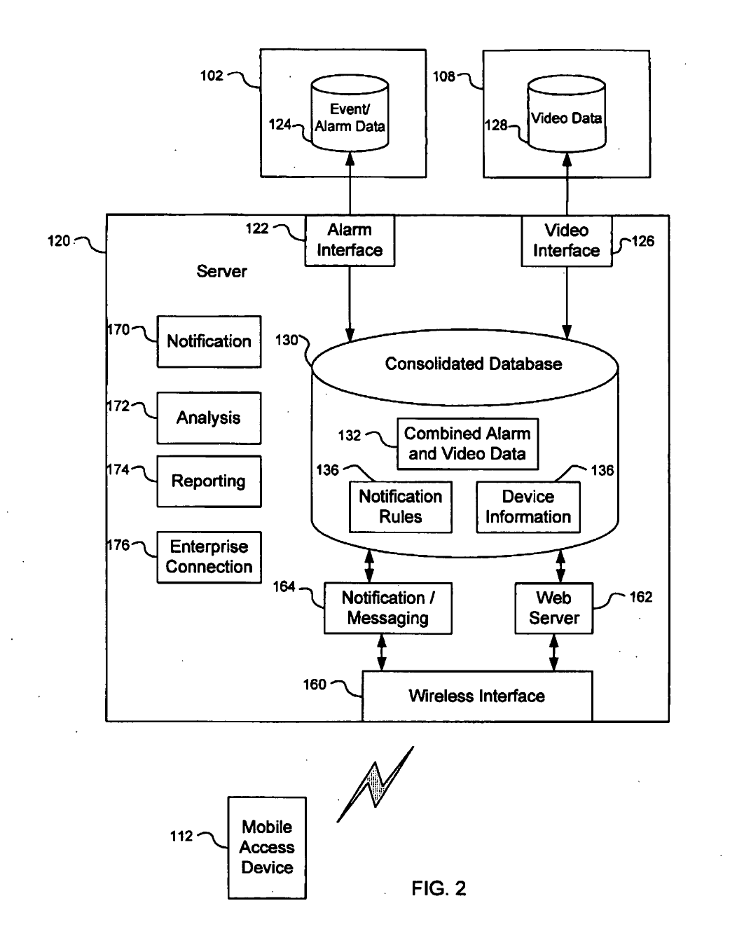

Referring to FIG. 2, one embodiment of the remote access system 120 may be implemented as a consolidated, server-based architecture used for the collection, storage and transmission of security event information. The remote access system 120 may include an alarm interface 122 that obtains event/alarm data 124 from the security event data collection system 102 and a video interface 126 that obtains video data 128 from the video surveillance system 108.

The remote access system 120 may obtain the event data and video data for both real-time use (e.g., notification of an event when the event occurs) and after the fact use (e.g., for use in a report on events). The remote access system 120 may employ a common mechanism to format event records in the consolidated database 130. In one example, an initialization file may be used to determine the fields that will reside in an event record and to determine the field ordering. The initialization file may provide an XML description of the event interface to specify record content and field ordering.

The consolidated database 130 links the event/alarm data and the video data corresponding to a particular event and stores the linked alarm and video data 132. The consolidated database 130 may be implemented as a relational database, for example, using a database server and database management system software such as the type available from Microsoft or Oracle. The linked event/alarm data and video data may be stored in a combined table in the consolidated database 130. Database synchronization software may be activated to transfer the security event data and/or video data to the consolidated database 130.

The video data linked to the event data may include digitized video clips as well as information about the video. The digitized video clips may be stored directly on the consolidated database 130 as embedded video. When digitized video is stored on the consolidated database 130, the embedded video clips may be stored in a highly compressed format using techniques known to those skilled in the art.

Alternatively, the digitized video clips may include linked video resident on a separate multimedia server (e.g., in the surveillance system 108). The digitized video clips on a separate multimedia server may also be associated with the event data on the consolidated database 130 through database relations. When the digitized video is stored in a separate location, the video data stored on the consolidated database 130 includes information about the video clips (e.g., time stamps and duration). In a further alternative, digitized video may also be streamed directly to and stored in the mobile access device 112.

The event/alarm data 124 and the video data 126 may be linked based on an indication of when a security event occurred. The event/alarm data 124 and the video data 126 include timestamps indicating the time that the events occurred and the time when the video was taken. Both the data collections system 102 and the video surveillance system 108 may use Universal Coordinated Time (UTC) from a hardware timestamp source to provide an accurate and consistent timestamp. Thus, event data corresponding to an event that occurred at a particular time and location may be linked to video data corresponding to a video taken at that time and at that location.

In addition to the alarm and video data 132, the consolidated database 130 may include a device management table 134 containing device information pertaining to the collection devices 104. The device management table 134 allows a user to obtain information on the collection devices 104 and/or to manage the collection devices 104 using the mobile access device 112. The consolidated database 130 may also include notification rules 136 that trigger notification processes, as described below. The mobile access device 112 may be used to customize the notification process by accessing and modifying the notification rules. Additionally, the rules may be modified externally over the World Wide Web using the web server 162.

One embodiment of the remote access system 120 may include a wireless interface 160 to connect with the mobile access device(s) 112 and to transmit data in a format suitable for wireless transmission. The wireless interface 160 may be implemented using wireless technologies known to those skilled in the art such as the short-range radio technology known as Bluetooth and various longer-range radio technologies such as cellular protocols.

The remote access system 120 may include a web server 162 to make the consolidated database 130 available to an access device 112. In one embodiment, the web server may be an Internet Information Services (IIS) Web server available from Microsoft. The web server 162 may be used to deliver the data on web pages, such as active server pages (ASP), in response to a hypertext transfer protocol (HTTP) request from a mobile access device 112.

The remote access system 120 may include a notification/messaging system 164 to provide notification of events. The notification/messaging system 160 may transmit an event or alarm message to the mobile access device 112, for example, on a subscription basis. In one embodiment, the message may be sent to the user in the form of an email with the event data and video data. The video data in the message may include an embedded video clip or a link to a location where the video clip is stored.

According to one embodiment, Web services publish/subscribe mechanisms may be used to provide notification of events. The remote access system 120 may support extensible markup language (XML), Simple Object Access Protocol (SOAP) and Uniform Device Discovery Interface (UDDI) standards. To provide both real-time and batch event information delivery, the remote access system 120 may also incorporate asynchronous messaging systems such as the messaging queue systems available from IBM under the name IBM MQ Series and from Microsoft under the name MSMQ. A messaging queue system is capable of delivering suitably formatted communications to subscribers using wired or wireless communications. The system may also use a time coordination protocol supported by asynchronous messaging, such as Lamport's Algorithm.

The remote access system 120 may also include information security protection using security technologies known to those skilled in the art. Examples of security technologies that may be used include two-factor authentication, Public Key Infrastructure (PKI) security, secure sockets layer (SSL) and digital certificates.

Connection to the consolidated database 130 may be implemented using standardized database connection technologies such as Open Database Connectivity (ODBC), Java Database Connectivity (JDBC) and ActiveX Data Objects (ADO). Enterprise Application Interface (EAI) applications may also use the database connection to direct data from the consolidated database 130 into enterprise applications known to those skilled in the art. Access to the data in the consolidated database 130 may be provided via XML I/O, database synchronization, an enterprise connection, or using other techniques known to those skilled in the art.

The remote access system 120, the data collection system 102, and the video surveillance system 108 may be networked using the Zero Configuration Networking (zeroconf) standards such as those implemented by Apple Computer under the name Rendezvous. The networked security system 100 may also be implemented using the Universal Plug and Play standard. The remote access system 120 may be implemented as a server appliance, for example, using the Server Appliance Kit (SAK) available from Microsoft.

The remote access system 120 may also run one or more scheduled or on-demand business processes 170, 172, 174, 176. A notification business process 170 may be run to initiate and manage the notification process that is performed using the notification/messaging system 164. An analysis process 172 may be run to perform a data analysis using the alarm and video data 132 in the consolidated database 130. A reporting process 174 may be run to generate reports including, for example, event and video data or device information stored in the consolidated database 130. An enterprise connection process 176 may be run to direct data from the consolidated database 130 into applications using an Enterprise Application Interface (EAI).

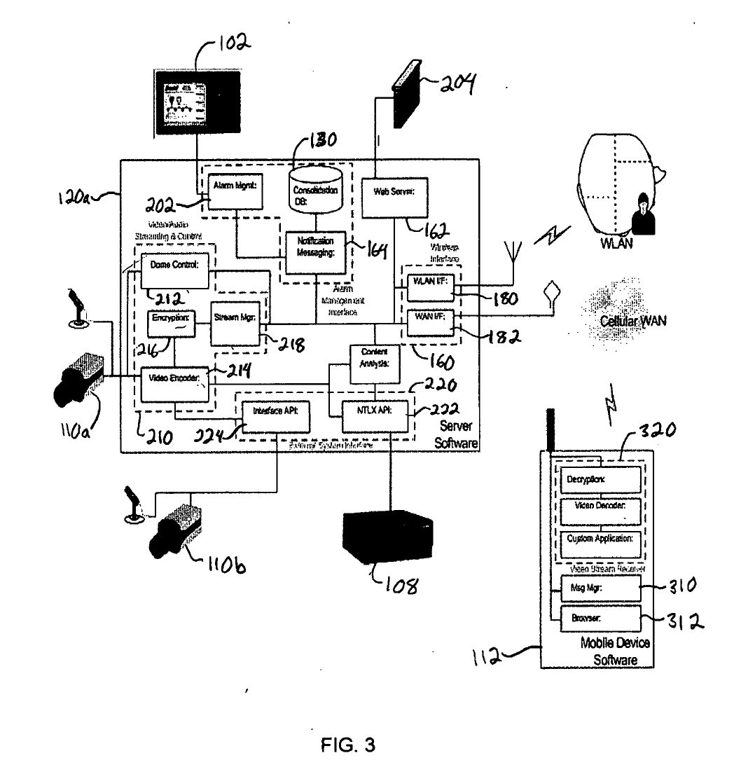

FIG. 3 shows another embodiment of a remote access system 120a. This embodiment of the remote access system 120a includes a consolidated database 130, a wireless interface 160, a web server 162, and a notification/messaging system 164, similar to the embodiments described above. In the remote access system 120a, according to this embodiment, the wireless interface 160 includes both a wireless LAN interface 180 and a cellular WAN interface 182. The remote access system 120a may include an alarm management interface 202 that interfaces with the data collection system 102 and manages the event/alarm data received from the data collection system 102. The web server 162 may be connected to a firewall 204 that restricts external access to the web server 162.

In this embodiment, the remote access system 120a also includes a video/audio streaming and control system 210 that controls a camera 110a and provides streaming video data for transmission over a wireless network. The video/audio streaming and control system 210 may include a dome control 212 that controls the positioning of the camera 104a using techniques known to those skilled in the art. The video/audio streaming and control system 210 may also include a video encoder 214 that encodes digitized video data, an encryption device 216 that encrypts the encoded video data, and a stream manager 218 that manages the stream of encrypted video data for transmission over a wireless network via the wireless interface 160.

The remote access system 120a, according to this embodiment, may also include an external system interface 220 interfacing with a camera 104b and a video surveillance system 108. The external system interface 220 may include a video recorder application programming interface (API) 222 that interfaces with the video surveillance system 108 and an interface API 224 that interfaces with the camera 104b.

As shown in FIG. 3, one embodiment of the mobile access device 112 may include a message manager 310, a browser 312 and a video stream receiver 320. The message manager 310 receives and manages notification messages transmitted from a remote access system 120, 120a. The browser 312 may be used to access the web pages provided by the web server 162. The video stream receiver 320 receives, decrypts and decodes streamed video data to allow a user to view the video using the access device 112.

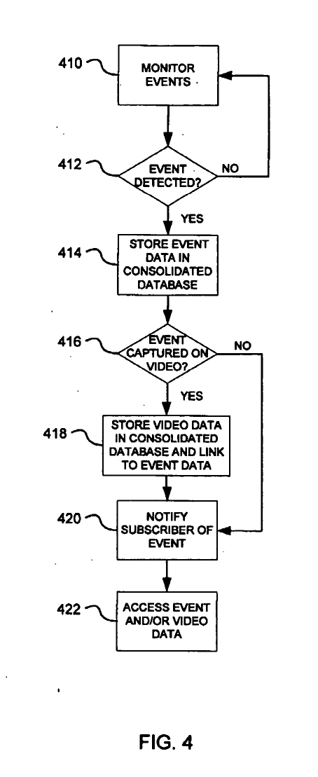

One method of remotely accessing security information is illustrated in FIG. 4. Security events are monitored 410 (e.g., using one or more detectors or data collection devices). When a security event is detected 412 and security event data is collected by the data collection system, the security event data is sent to the consolidated database and stored 414. If the event has been captured 416 on video (e.g., by a video surveillance system), video data pertaining to the captured video may be stored 418 in the consolidated database and linked to the event data. Some or all of the captured video may be stored with the event data, or the event data may be linked to captured video stored in a separate location (e.g., on the video surveillance system). A user or subscriber is notified 420 of the event using the mobile access device (e.g., by a message including event and video data such as an embedded video clip or a link to a video clip).

When the user receives the notification on the mobile access device, the user may acknowledge the alarm or event and access 422 the event and video data stored on the consolidated database. When accessing the video data, the user may use the mobile access device to manipulate the video data (e.g., by fast forwarding, rewinding, scanning, or zooming in/out). In an alternative method, video data may be streamed directly to the mobile access device in real time.

Embodiments of the system and method for remote access to security event information can be implemented as a computer program product for used with a computer system. Such implementation includes, without limitation, a series of computer instructions that embody all or part of the functionality previously described herein with respect to the system and method. The series of computer instructions may be stored in any machine-readable medium, such as semiconductor, magnetic, optical or other memory devices, and may be transmitted using any communications technology, such as optical, infrared, microwave, or other transmission technologies. It is expected that such a computer program product may be distributed as a removable machine-readable medium (e.g., a diskette, CD-ROM), preloaded with a computer system (e.g., on system ROM or fixed disk), or distributed from a server or electronic bulletin board over the network (e.g., the Internet or World Wide Web).

Those skilled in the art should appreciate that such computer instructions can be written in a number of programming languages for use with many computer architectures or operating systems. For example, preferred embodiments may be implemented in a procedural programming language (e.g., “C”) or an object oriented programming language (e.g., “C++” or Java). Alternative embodiments of the invention may be implemented as pre-programmed hardware elements or as a combination of hardware and software.

In summary, a security system consistent with one embodiment of the present invention includes a security event data collection system configured to collect security event data and a video surveillance system configured to record images of security events and to generate video data. A remote access system is configured to receive security event data from the security event data collection system and to receive video data from the video surveillance system. The remote access system is also configured to link received video data to received security event data associated with a security event. The remote access system may include at least one consolidated database configured to store the linked security event data and video data. The remote access system may also be configured to provide access to the linked security event data and video data from an access device.

Consistent with another embodiment of the present invention, a system for providing remote access to security event information includes an alarm interface configured to connect with a security event data collection system and to receive security event data and a video interface configured to connect to a video surveillance system and to receive video data. The remote access system may also include a consolidated database configured to link the video data received from the video surveillance system to the security event data received from the security event data collection system and to store the linked video and security event data. The remote access system may also include a wireless interface configured to connect to a mobile access device and to provide linked video and security event data to the mobile access device over a wireless network. The remote access system may further include a notification system configured to transmit a notification message to the mobile access device providing notification of an event.

Consistent with a further embodiment of the present invention, a method of providing remote access to security event information includes: receiving security event data indicative of security events detected by a security event data collection system; receiving video data associated with images of security events recorded by a video surveillance system; linking security event data indicative of a security event to video data associated with the security event; storing the linked alarm and video data in a consolidated database; and transmitting the linked alarm and video data from the consolidated database to a mobile access device.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A security system comprising:
a security event data collection system configured to collect security event data;
a video surveillance system configured to record images of security events and to generate video data; and
a remote access system being configured to receive security event data from said security event data collection system and to receive video data from said video surveillance system, said remote access system being configured to link received video data to received security event data associated with a security event, said remote access system including at least one consolidated database configured to store said linked security event data and video data, and said remote access system being configured to provide access to said linked security event data and video data from an access device.

2. The security system of claim 1 wherein said security event data collection system comprises:
at least one detection device configured to detect security events and to generate alarm data associated with said detected security events; and
at least one security event database configured to store said alarm data.

3. The security system of claim 1 wherein said security event data collection system includes at least one system selected from the group consisting of an electronic article surveillance (EAS) system, a radio frequency identification (RFID) system, a motion detection system, an entry/exit monitoring system, a glass window and door breakage detection system, temperature sensing system, a fire detection system, a gas detection system, an intrusion detection system, and an electronic access control system.

4. The security system of claim 1 wherein said video data stored on said consolidated database and linked to said event data includes digitized video clips.

5. The security system of claim 1 wherein said video data stored on said consolidated database and linked to said event data includes information about digitized video clips stored on said video surveillance system.

6. The security system of claim 1 wherein said remote access system includes a web server configured to provide access to said linked security event data and video data and other data stored in said consolidated database.

7. The security system of claim 1 wherein said remote access system includes a notification system configured to notify a mobile access device of an event.

8. The security system of claim 1 wherein said security event data collection system is an object recognition system.

9. A system for providing remote access to security event information, said system comprising:
an alarm interface configured to connect with a security event data collection system and to receive security event data;
a video interface configured to connect to a video surveillance system and to receive video data; and
a consolidated database configured to link said video data received from said video surveillance system to said security event data received from said security event data collection system and to store said linked video and security event data;
a wireless interface configured to connect to a mobile access device and to provide linked video and security event data to said mobile access device over a wireless network; and
a notification system configured to transmit a notification message to said mobile access device providing notification of an event.

10. The system of claim 9 wherein said consolidated database is configured to store device management tables including device information associated with detection devices in said security event data collection system.

11. The system of claim 9 wherein said consolidated database is configured to store notification rules governing processes for notifying said mobile access device of security events.

12. The system of claim 9 further comprising a web server configured to provide said linked alarm and video data to said mobile access device.

13. A method of providing remote access to security event information, said method comprising:
receiving security event data indicative of security events detected by a security event data collection system;
receiving video data associated with images of security events recorded by a video surveillance system;
linking security event data indicative of a security event to video data associated with said security event;
storing said linked alarm and video data in a consolidated database; and
transmitting said linked alarm and video data from said consolidated database to a mobile access device.

14. The method of claim 13 wherein said security event data is indicative of at least one event selected from the group consisting of a door opening, a point of sale (POS) transaction, detection of an active electronic article surveillance (EAS) tag, and proximity of a radio frequency identification (RFID) label.

15. The method of claim 13 wherein said security event data and said video data is linked using time stamps associated with said security event data and said video data.

16. The method of claim 13 wherein said video data received and stored on said consolidated database includes digitized video clips.

17. The method of claim 13 wherein said video data received and stored on said consolidated database includes information about digitized video clips stored on a multimedia server in said video surveillance system.

18. The method of claim 13 wherein receiving said security event data and said video data includes synchronizing said consolidated database with a security event database in said security event data collection system.

19. The method of claim 13 wherein transmitting said linked alarm and video data from said consolidated database to said mobile access device includes providing said linked alarm and video data on a web server.

20. The method of claim 13 further comprising notifying a subscriber of an event according to rules stored on said consolidated database.

21. A machine-readable medium whose contents cause a computer system to perform a method of providing remote access to security event information, said method comprising:
receiving security event data indicative of security events detected by a security event data collection system;
receiving video data representing recorded video associated with at least one of said security events detected;
linking said security event data to said video data associated with said security events indicated by said security event data;
storing said linked alarm and video data in a consolidated database; and
transmitting said linked alarm and video data to an access device.

22. The machine-readable medium of claim 21, said method further comprising notifying a subscriber of an event according to rules stored on said consolidated database.
